(19) United States
(12) Patent Application Publication
(10) Pub. No.: US 2011/0251817 A1
(43) Pub. Date: Oct. 13, 2011

(54) METHOD AND APPARATUS TO DETERMINE IMPEDANCE VARIATIONS IN A SKIN/ELECTRODE INTERFACE

(75) Inventors: Mark Burns, McKinney, TX (US); Rainer J. Fink, College Station, TX (US)

(73) Assignee: Reproductive Research Technologies, LLP, Houston, TX (US)

(21) Appl. No.: 12/758,552

(22) Filed: Apr. 12, 2010

(51) Int. Cl. G06F 19/00

(52) U.S. Cl. 702/104

(57) ABSTRACT

The present invention relates to a system for measuring the impedance of a skin/electrode interface and selectively modifying the system gain of the monitoring circuit to compensate for errors introduced by variations in the skin/electrode impedance. More particularly, a simplified, low-cost method for measuring and compensating for skin/electrode impedance variations is provided. The skin/electrode impedance measuring circuit and determines a system gain correction factor which may be applied to the measured signal using a software algorithm, thereby eliminating the need to change the circuit topology with a programmable gain amplifier or programmable resistor network.

### FIELD

Embodiments of the disclosure relate to medical devices and systems, and more particularly to medical devices for measuring electrical signals generated by a patient's body.

### BACKGROUND

In a medical environment, the selectivity and variability of the input impedance of an electronic monitoring device used to monitor electrical signals generated by a patient's body is an important, though somewhat under-emphasized feature of the overall monitoring device. Such electrical signals may include electrocardiographic (“ECG”), electromyographic (“EMG”), or electroencephalographic (“EEG”) signals. As the sensitivity of a particular electronic monitoring device/system increases, it becomes increasingly important to consider the inaccuracy of measurements created by offset and gain errors caused by unknown or changing skin/electrode impedances. The effect is often significant enough to create an inability to monitor important electrical events during medical procedures.

In an attempt to compensate for the anticipated error caused by impedance uncertainty from patient to patient, many medical monitoring applications obtain independent measurements of the patient skin/electrode impedance prior to the initiation of electrical monitoring. However, it is well known that the skin/electrode impedance can, and often does, change during an extended monitoring process while the electrodes are coupled to the patient. The induced error can originate from a variety of sources, for example, the adhesive deterioration of the electrode connection, patient perspiration, patient dehydration, etc. Even in the event of a pre-monitoring impedance measurement, hardware or software solutions to correct for the induced error during the monitoring process are noticeably scarce.

Therefore, what is needed is a system for monitoring the skin/electrode impedance of a patient and altering the gain of the system to compensate for the effects of the continuously-changing skin impedance.

### BRIEF SUMMARY OF THE INVENTION

Embodiments of the disclosure may provide a method for compensating for an impedance variation of a biopotential signal of a patient. The method can include applying a pair of electrodes to a skin of the patient, applying a test signal to the skin of the patient via the pair of electrodes, and measuring a combined response to the test signal by the skin and the pair of electrodes. The method can further include calculating an output impedance of the skin and the pair of electrodes using the combined response to obtain a mathematical correction of the biopotential signal of the patient that is used to compensate for the impedance variation caused by the skin and the pair of electrodes.

Embodiments of the disclosure may further provide a system for compensating for an impedance variation of a biopotential signal of a patient. The system may include selectively variable impedance electrodes applied to a skin of the patient, a monitoring module communicably coupled to the electrodes, and a test generating module communicably coupled to the monitoring module and the electrodes and configured to apply a test signal to the electrodes. The system can further include a measurement module having a voltage calibration meter configured to measure a DC level between the electrodes while the test signal is applied to the electrodes, whereby a total impedance of the electrodes and skin is measured and a gain of the monitoring module is adjusted proportionally to account for the impedance variation.

Embodiments of the disclosure may provide another system for compensating for an impedance variation of a biopotential signal of a patient. The illustrative system can include selectively variable impedance electrodes applied to a skin of the patient, a monitoring module communicably coupled to the electrodes, and a test generating module communicably coupled to the monitoring module and the electrodes and configured to apply a test signal to the electrodes. The system may further include a measurement module having a voltage calibration meter configured to measure an AC level between the electrodes while the test signal is applied to the electrodes, whereby a total impedance of the electrodes and skin is measured and a gain of the monitoring module is adjusted proportionally.

### BRIEF DESCRIPTION OF THE DRAWINGS

The present disclosure is best understood from the following detailed description when read with the accompanying Figures.

FIG. 1 illustrates an exemplary system for measuring skin and electrode impedances concurrently with a biopotential monitoring device, according to one or more embodiments of the disclosure.

FIG. 2 illustrates another exemplary system for measuring skin and electrode impedances concurrently with a biopotential monitoring device, according to one or more embodiments of the disclosure.

FIG. 3 illustrates an exemplary system for measuring skin and electrode impedances, including embodiments disclosed in FIGS. 1 and 2.

FIGS. 4A and 413 illustrate an exemplary calibration method according to the system disclosed in FIG. 1.

FIG. 5 illustrates an exemplary calibration method according to the system disclosed in FIG. 2.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure, however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

Embodiments of the disclosure provide an impedance compensation system and method designed to provide relatively stable, impedance-independent output signals that may be subsequently monitored and/or displayed. Exemplary output signals may include biopotential electrical signals derived from a patient, such as ECG, EMG, or EEG signals. In brief, exemplary embodiments may include a system and method for measuring the combined impedance of a patient's skin plus the skin/electrode interface, whereby the gain of the overall measurement device may be modified to compensate for measured variations in the total skin/electrode impedance. In at least one embodiment, the gain may be modified using software multiplication of the monitored signal by a calibration factor. To ensure accurate output signals over long periods of time, the calibration factor may be periodically recalculated and updated from the measured skin/electrode impedance.

It should be noted at the outset that embodiments disclosed herein may include two-electrode systems designed for battery operation with a wireless or optical link to a nearby display unit. However, in embodiments connected in any way to earth ground or powered by electrical outlets, a third wire may be coupled to the patient's leg or other body point in an effort to force the patient's body toward a DC voltage compatible with the measurement circuitry. In battery-operated embodiments, this is not necessary, since the midpoint voltage or analog ground of a battery-operated measuring circuitry can simply be referenced to the patient's intrinsic body voltage through the two sensing electrodes.

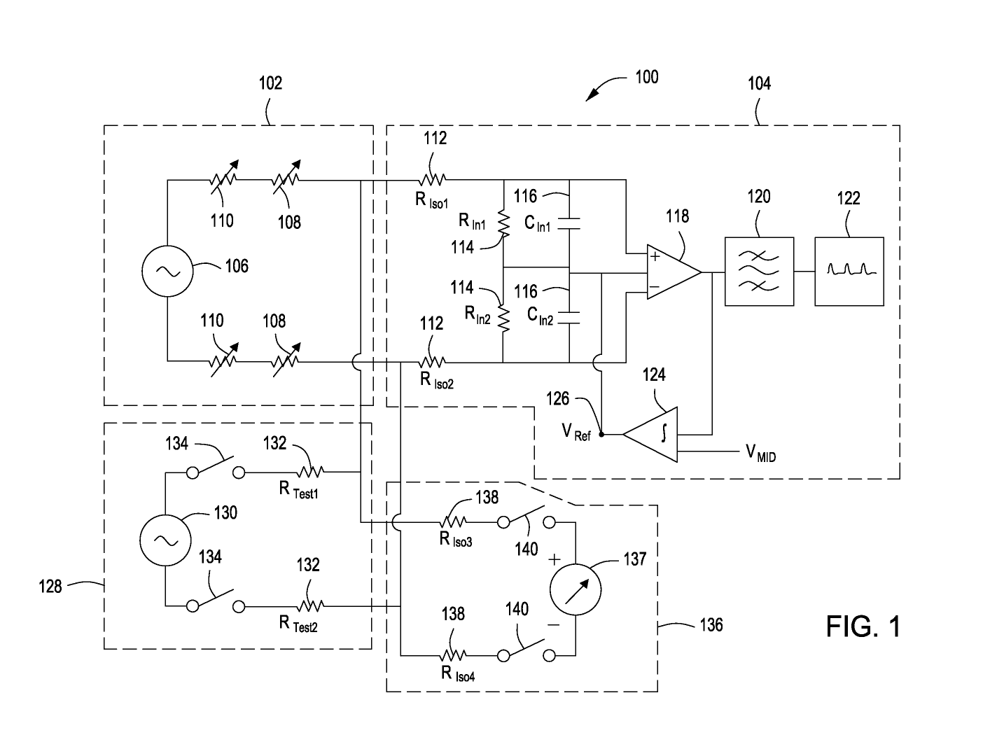

Referring now to FIG. 1, illustrated is an exemplary embodiment of a system 100 for measuring skin and electrode impedances including a conventional biopotential monitoring device 104 designed to monitor and display biopotential electrical signals derived from a patient 102. Particularly, a patient 102 may naturally emit a biopotential signal 106, such as an ECG, EMG, or EEG signal, which may be monitored via the monitoring module 104. The patient 102 may be coupled to the monitoring module 104 via a pair of electrodes 108 attached or otherwise affixed to the skin 110 of the patient. In other exemplary embodiments, the electrodes may be placed or inserted into the skin 110.

In an exemplary embodiment, the impedance of the electrodes 108 and the skin 110 may be predominantly resistive, with little or no capacitive or inductive characteristics at the frequencies of interest. Moreover, the impedance of the electrodes 108 and skin 110 may vary with respect to time and, therefore, are illustrated as variable resistances in FIG. 1.

In an exemplary embodiment, the biopotential signal 106 from the patient 102 can be a very small signal, for example, possibly only a few millivolts or less in amplitude. Further, the biopotential signal 106 may be monitored in the presence of interfering signals, as the body of the patient 102 naturally acts as an antenna, picking up signals having amplitudes of greater than a few millivolts. In order to reduce or completely eliminate these interfering signals, the system 100 may employ a low-pass filter network formed by isolation resistors 112, input resistors 114, and input capacitors 116. In an exemplary embodiment, both differential and common-mode interference signals, such as large-amplitude radio signals, may be eliminated through the low-pass filter network.

The isolation resistors 112 may include resistances sufficient to isolate the patient 102 from potentially life threatening voltages inadvertently coupled into the monitoring module 104, and also supply an added level of downstream electrostatic discharge protection. In an exemplary embodiment, the isolation resistors 112 may have a known value, such as 100 kOhms or greater. Moreover, the input resistors 114 and input capacitors 116 may also have known values that may be used by the system 100 for reference, as will be described below.

Since the respective impedances of the electrodes 108 and patient skin 110 may vary over time, the resultant signal measured by the monitoring module 104 will also vary over time, in accordance with Ohm's law. This is due, in part, to the resulting change in the resistor divider network created by the skin 110, the electrodes 108, and resistors 112 and 114. It is this undesirable and unpredictable change in signal amplitude that the present disclosure may be configured to compensate for.

The monitoring module 104 may also include an amplifier 118 and a supplemental filter/gain module 120. In an exemplary embodiment, the amplifier 118 may include an instrumentation amplifier. The supplemental filter/gain module 120 may include a low-pass filter, but may also in other embodiments include a band-pass filter. In at least one embodiment, the supplemental filter/gain module 120 may be configured to filter the incoming frequencies to a band between about 0.2 Hz to about 2.0 Hz. In other embodiments, the supplemental filter/gain module 120 may be configured to filter the incoming frequencies to a band between about 0.3 Hz to about 1.0 Hz.

Furthermore, depending on the design requirements of the system 100, the amplifier 118 may have a gain of between about 10 to about 2000. In an exemplary embodiment, the required total gain of the amplifier 118 and the supplemental filter/gain module 120 may be between about 1000 to about 2000 V/V, so as to provide a strong enough output signal for subsequent processing and display on a signal processing and display unit 122. Therefore, in instances where the amplifier 118 is used as a low gain preamplifier having a low gain, for example, a gain of only about 10, additional gain may then be acquired via the supplemental filter/gain module 120, which can be implemented using at least one integrated operational amplifier circuit (not shown).

In applications where the gain of the monitoring module 104 is high, small changes of DC offset in the biopotential signal 106 may result in clipped output voltages at the output of either the amplifier 118 or the filter/gain module 120, or both. The system 100, therefore, may further include a servo integrator 124 configured for high-pass filtration to block any DC offset present in the biopotential signal 106 or generated by the input circuitry of the amplifier 118. In an exemplary embodiment, the servo integrator 124 may be coupled to a V_{REF} node 126 of the amplifier 118, input resistors 114, and input capacitors 116.

In exemplary operation, the servo integrator 124 may ramp up or down until the output of the amplifier 118 attains a desired mid-voltage V_{MID}. As is well known by those skilled in the art, an integrator in a feedback path, as is illustrated in FIG. 1, forms a high-pass filter in the forward path. Therefore, the servo integrator 124 may provide the required DC blocking functionality required by the system 100. Moreover, as can be appreciated by those skilled in the art, the body of the patient 102 may naturally force the V_{REF} node 126 of the monitoring module 104 toward the average voltage of the electrodes 108 by way of the resistors 112,114. Therefore, any changing common-mode DC offset from the body of the patient 102 may naturally correct itself by way of the resistors 112,114.

In another exemplary embodiment, the resistors 112,114 may be replaced by at least one variable resistance network. Such an embodiment is disclosed in co-pending U.S. Pat. Pub. No. 2008/0275316, entitled “Skin Impedance Matching System and Method for Skin/Electrode Interface,” the content of which is herein incorporated by reference in its entirety, to the extent that it is not inconsistent with the present disclosure. However, the exemplary embodiments disclosed therein may require large resistance values, thereby resulting in a high cost of manufacturing for an integrated circuit, since large resistances typically require a relatively large and expensive area on integrated circuits. On the other hand, as described below, embodiments of the present disclosure may provide an equivalent system or configuration for compensating for variations in the impedances of the electrodes 108 and skin 110 without requiring expensive, custom-integrated circuitry.

Still referring to FIG. 1, the system 100 may also include a test signal generating module 128 configured to operate in either a “Normal Mode” or a “Calibration Mode.” The test signal generating module 128 may provide a test signal 130 that may be selectively applied, or disconnected, from a pair of test resistors 132 by means of corresponding switches 134. In exemplary embodiments, the test signal 130 may include several types of signals, for example, DC levels, square waves, sine waves of varying frequencies and amplitudes, pulse-width modulated digital waveforms, etc. Furthermore, the test signal 130 may originate from a DC or AC source. In at least one embodiment, the signal 130 may originate with a 3.2V battery or other DC power supply.

During an exemplary Normal Mode of operation, the switches 134 may be situated in the open position (as illustrated), thereby allowing the sensing circuitry (combination of patient 102 and monitoring module 104) to operate normally by acquiring biopotential signals 106 from the patient 102. During an exemplary Calibration Mode of operation, the switches 134 are situated in the closed position, thereby connecting the test signal 130 to the electrodes 108 via the test resistors 132.

In one exemplary embodiment, the Calibration Mode may include applying a differential DC test signal 130 across the electrodes 108 through the test resistors 132 and switches 134. Other embodiments may include a single-ended DC test signal 130. As will be explained below, this may allow for a simple and direct measurement of the total impedance created by the resistances of the two electrodes 108 and the skin 110, combined.

Also included in the exemplary system 100 illustrated in FIG. 1 may be a measurement module 136 having a voltage calibration meter 137 configured to, in at least one embodiment, measure the DC level between the two electrodes 108 while the test signal 130 is applied to the electrodes 108 during a calibration mode. In an exemplary embodiment, the measurement module 136 may include a pair of isolation resistors 138 with corresponding switches 140. The isolation resistors 138 may be configured to isolate the patient 102 from potentially dangerous stray electrical signals originating from the measurement module 136, and also to prevent electrostatic discharge voltages from the patient 102 from entering the circuitry of the measurement module 136.

During a Normal Mode of operation of the system 100, the switches 140 may be in the open position, as illustrated, thereby disconnecting the voltage calibration meter 137 from the electrodes 108 and avoiding electrical interference from the measurement module 136. It will be appreciated that the reactive effects of the input capacitors 116 may be ignored provided that enough time is allowed for the test signal 130 at the electrodes 108 to settle to a DC level.

During a Calibration Mode of operation of the system 100, the switches 140 may be closed and simple resistor divider calculations (based on Ohm's law) may provide the value of the total impedance of the resistive electrodes 108 and skin 110, as measured between the electrodes 108. Once the total impedance is known, the gain (i.e., attenuation) of the input resistor network may be obtained.

For example, in accordance with Ohm's law, let R₁ be the total of the six resistances including the electrodes 108, the skin 110, and the isolation resistors 112. Let R₂ be the input resistance of the two input resistors 114. Consistent with Ohm's law, the gain of the path of the test signal 130 between the biopotential signal 106 and the input of the amplifier 118 is equal to R₂ divided by R₁ plus R₂. As can be appreciated, therefore, the output signal of the monitoring module 104 may then be corrected or adjusted by dividing the output of the supplemental filter/gain module 120 by the resultant gain value, or calibration factor. Thus, the gain of the overall system 100 may be modified using the calculated calibration factor to compensate for the variations in the total skin/electrode impedance.

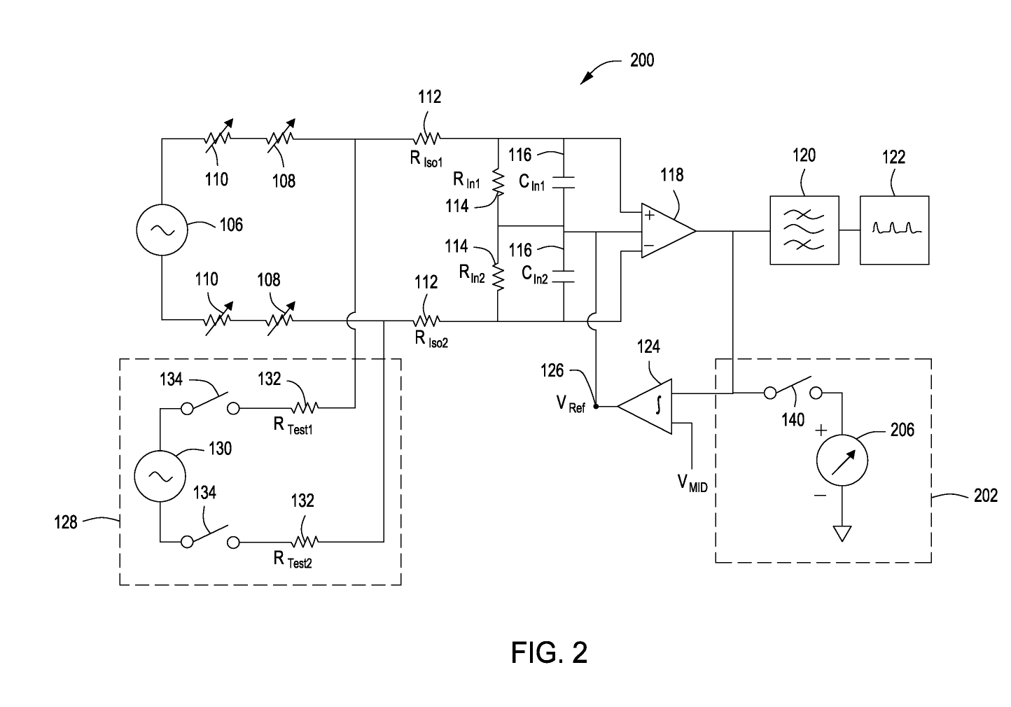

Referring now to FIG. 2, with continuing reference to FIG. 1, illustrated is another exemplary embodiment where elements described in FIG. 1 are referred to by analogous numerals in FIG. 2. Specifically, FIG. 2 illustrates a system 200 that may be configured to provide higher noise immunity than the embodiments disclosed in FIG. 1, by eliminating potential noise that could be introduced into the monitoring module 104 via the measurement module 136 (FIG. 1).

As illustrated, the output of the amplifier 118 may be communicably coupled to a measurement module 202, now used as the measurement node of the system 200. As described above, the amplifier 118 may be an instrumentation amplifier. By design, the output impedance of the amplifier 118 may be much lower than the impedance at its inputs; therefore the measurement module 202 may be far less susceptible to any noise induced by the measurement circuitry connected thereto.

In an exemplary embodiment, the output of the instrumentation amplifier 118 may be connected via a switch 204 to a voltage calibration meter 206, wherein the voltage calibration meter 206 may be adapted to be responsive to AC signals. As can be appreciated by those skilled in the art, the measurement module 202 may be responsive to AC signals since the amplifier 118 and servo integrator 124 form a high-pass filter, therefore making it difficult to pass DC signals through the amplifier 118. Accordingly, the test signal 130 originating from the test signal generating module 128 may be a time varying signal, such as a square wave or sine wave, containing frequency components that are high enough to pass through to the output of the amplifier 118.

In another exemplary embodiment, however, the servo integrator 124 may be disabled, thereby allowing a DC signal to be applied through the system 200 from the test signal generating module 128. In this exemplary embodiment, the gain of the amplifier 118 may be set at about 10 so as to avoid clipping any DC output voltages. In at least one embodiment, the servo integrator 124 may be disabled through, for example, a programmable “mode” which may be configured to simply turn off the servo integrator 124 and allow a DC signal influx.

Similar to the exemplary embodiments disclosed with reference to FIG. 1, the effects of the unknown impedances of the electrodes 108 and skin 110 on the resulting output signal measured at the voltage calibration meter 206 may be calculated based on the known values of the input resistor network, which may include the isolation resistors 112, input resistors 114, and input capacitors 115, and the overall gain of the amplifier 118.

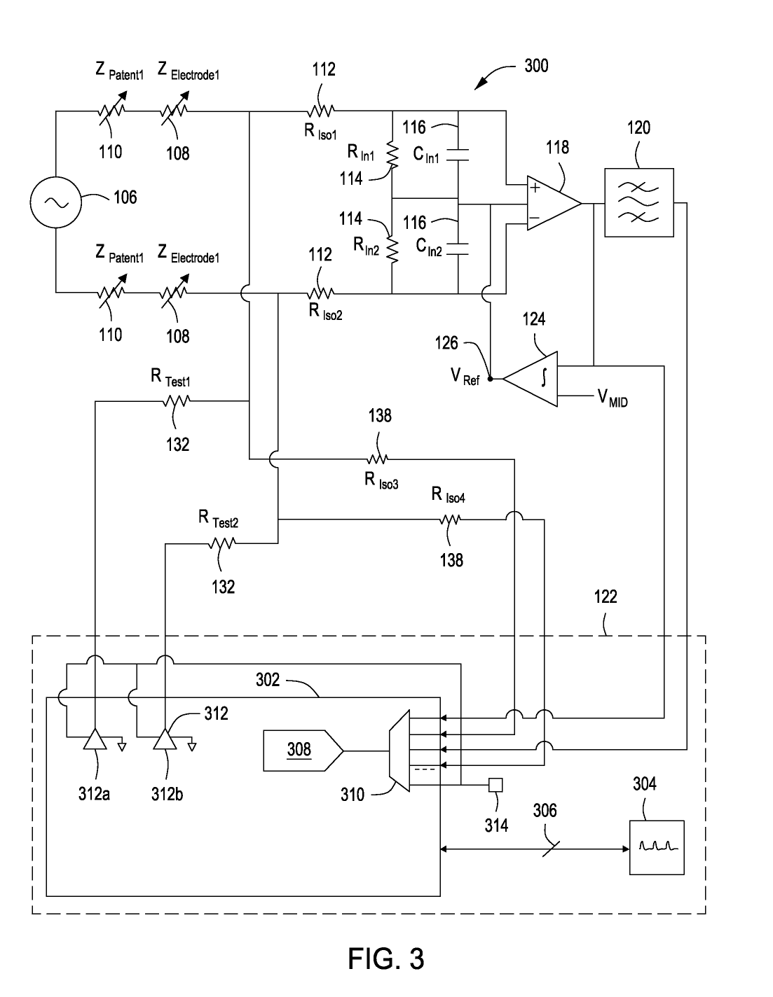

Referring now to FIG. 3, illustrated is another exemplary embodiment of a system 300 according to the present disclosure. As illustrated, elements described with reference to FIGS. 1 and 2 are referred to also in FIG. 3 by analogous numerals and therefore will not be described again in detail. In at least one embodiment, the illustrated system 300 may be configured to implement any or all of the embodiments disclosed with reference to FIGS. 1 and 2. A description of the internal circuitry of the signal processing and display unit 122 follows.

In an exemplary embodiment, the signal processing and display unit 122 may include a microprocessor 302 and a display unit 304. In at least one embodiment, the display unit 304 may be configured as a user interface including a PC or laptop, or any hand-held device, such as a cellular phone, PDA, or BLACKBERRY® device. In other embodiments, the display unit 304 may include a fax or printer, such as a strip chart recorder. The microprocessor 302 may be communicably coupled to the display unit 304 through an interface 306. In an exemplary embodiment, the interface 306 may include a wireless or optical interface, thereby advantageously maintaining isolation from earth ground and electrical power outlet voltages. In exemplary embodiments, the interface 306, therefore, may include an optical data bus, a wireless local area network (such as IEEE 802.11), or support BLUETOOTH® wireless technology.

As illustrated, the microprocessor 302 may include an analog to digital (“A/D”) converter 308, an analog multiplexer 310, and a pair of general purpose digital input/output (“I/O”) pins 312, or drivers. In an exemplary embodiment, the A/D converter 308 may be configured to capture incoming signals from the supplemental filter/gain module 120. Additionally, the A/D converter 308 may be configured to perform substantially similar functions as the voltage calibration meters 137 and 206, as described above with reference to FIGS. 1 and 2, respectively.

The analog multiplexer 310 may be communicably coupled to both the A/D converter 308 and the supplemental filter/gain module 120. In an exemplary embodiment, the analog multiplexer 310 may be configured to function substantially similar to the measurement switches 134 and 140, as disclosed in FIGS. 1 and 2, respectively. The I/O pins 312 may supply the test signal 130 voltage, as described in FIGS. 1 and 2. To be able to supply the test signal 130, the I/O pins 312 may be communicably coupled to a voltage supply 314. As explained above, the voltage supply 314 may include, but is not limited to, battery power, AC-type current, or DC-type current.

In exemplary operation, the system 300 may be configured to operate in a Normal Mode and a Calibration Mode, as described above with reference to FIGS. 1 and 2, wherein the Normal Mode may acquire biopotential signals 106 for processing and display, and the Calibration Mode compensates for the varying impedances of the electrodes 108 and skin 110. In an exemplary embodiment, switching between Normal and Calibration modes may be accomplished via the analog multiplexer 310.

During Normal Mode operation, the voltage level produced by a Logic Low (0) state of the I/O pins 312 may be 0V. However, during Calibration Mode operation, the voltage level produced by the Logic High (1) state of the I/O pins 312 may be equal to the voltage supply 314, thereby transmitting a test signal 130 to the system 300 via the I/O pins 312. In an exemplary embodiment, the I/O pins 312 may be tristated under control of software embedded in the microprocessor 302 and configured to perform a function similar to the opening of the switches 134, as described in FIGS. 1 and 2.

Moreover, software embedded in the microprocessor 302 may be used to perform all the measurement and compensation methods described in the embodiments illustrated and discussed in FIGS. 1 and 2. For example, the microprocessor 302 may be configured to measure the impedances of the electrodes 108 and skin 110. Also, the microprocessor 302 may be configured to determine and apply the gain calibration factor to the biopotential signal 106 before it is displayed by the display unit 304. As can be appreciated by those skilled in the art, the exemplary system 300 may be appropriately simplified by implementing only one of the embodiments described in FIG. 1 or 2.

In at least one embodiment, the voltage supply 314 may vary as the supply source (e.g., batteries) discharges over time, therefore affecting the test signal 130 voltage level proportionally. To compensate for this potential variance, the digital voltage supply 314 may be continuously monitored by the microprocessor 302 as part of the processing during the Calibration Mode. When decreased voltage levels of the test signal 103 are registered, the microprocessor 302 may be configured to proportionately adjust its calculations accordingly.

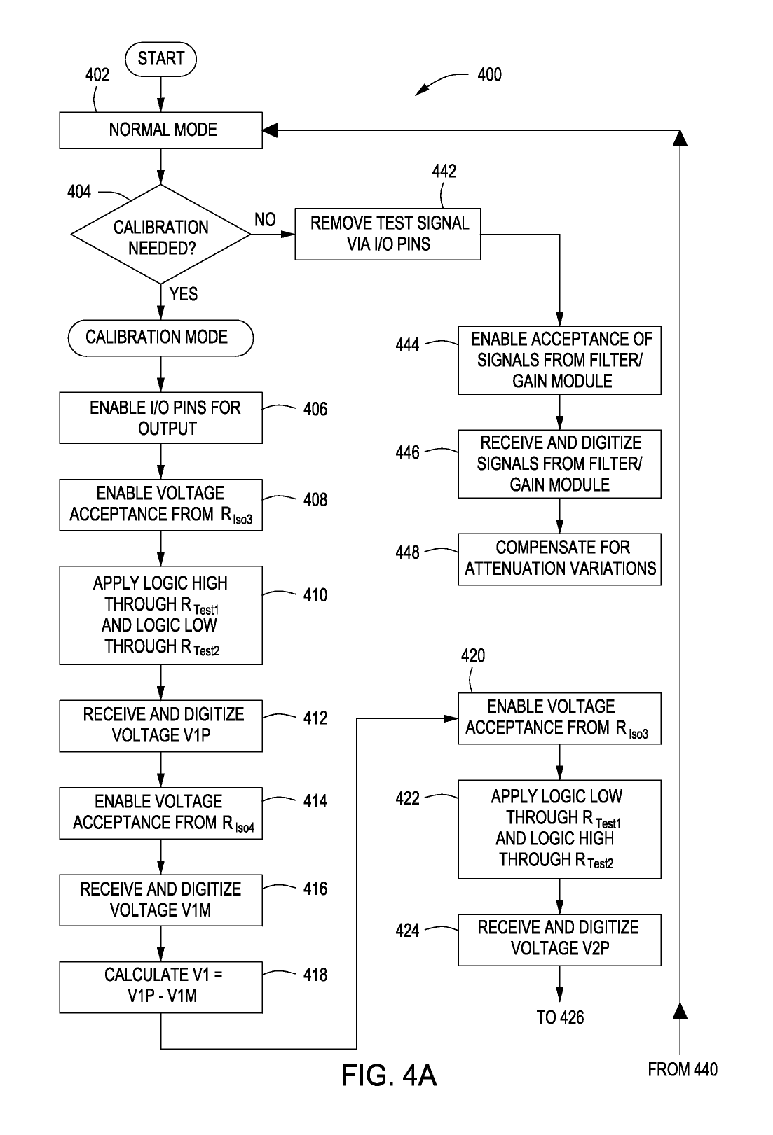

Referring now to FIG. 4, with continued reference to FIG. 3, illustrated is a flowchart describing a method of operation 400 for a Calibration and Normal Mode in accordance with the embodiments described with reference to FIG. 1. In an exemplary embodiment, the system 300 (FIG. 3) may initiate operation in the Normal Mode, as at 402. In the Normal Mode, a query is posed to decide whether the system 300 should continue in Normal Mode or whether the program flow requires a switch to the Calibration Mode, as at 404. In at least one embodiment, the decision may be based on how much time has elapsed since the last calibration. In another exemplary embodiment, a decision may indicate that a single calibration on power-up of the system 300 is adequate for the particular measurement application.

Upon entering the Calibration Mode, the I/O pins 312 may first be enabled for output, as at 406. In at least one embodiment, a first differential DC voltage may be applied by the I/O pins 312 through the test resistors 132 and the resulting differential voltage “V1” acquired at the electrodes 108 may be measured by the A/D converter 308 through isolation resistors 138 and the input multiplexer 310.

To acquire a first measurement of the differential voltage V1 between the two electrodes 108, the microprocessor 302 may first be configured to enable the multiplexer 310 to accept a voltage at a first isolation resistor 138 (FIG. 3 “R_{Iso3}”), as at 408. In an exemplary embodiment, the input multiplexer 310 may be used to sequentially select the positive and negative voltages of the differential voltage acquired at the electrodes 108, since the A/D converter 308 includes a single-ended input. The microprocessor 302 may then be configured to apply Logic High (1) from a first I/O pin 312a through one test resistor 132 (FIG. 3 “R_{Test1}”), and subsequently apply Logic Low (0) from a second I/O pin 312b through another test resistor 132 (FIG. 3 “R_{Test2}”), as at 410.

The A/D converter 308 may then be configured to receive and digitize a first incoming voltage “V1P”, as at 412, at which point the microprocessor 302 may be configured to enable the input multiplexer 310 to accept a voltage at a second isolation resistor 138 (FIG. 3 “R_{Iso4}”), as at 414. The A/D converter 308 may then be configured to receive and digitize a second incoming voltage “V1M”, as at 416, at which point the first measurement of the differential voltage V1 may be calculated by subtracting V1M from V1P, as at 418. As can be appreciated by those skilled in the art, other embodiments employing an A/D converter 308 with a differential input and differential input multiplexer 310 may serve to simplify the process of measuring the differential voltage V1.

To acquire a second measurement of the differential voltage “V2” between the two electrodes 108, the microprocessor 302 may be configured to reverse the polarity of the input voltage applied at I/O pins 312. To accomplish this, the microprocessor 302 may again be configured to enable the multiplexer 310 to accept a voltage at the first isolation resistor 138 (“R_{Iso3}”), as at 420. The microprocessor 302 may then be configured to apply Logic Low (0) from the first I/O pin 312a through one test resistor 132 (“R_{Test1}”), and subsequently apply Logic High (1) from the second I/O pin 312b through another test resistor 132 (“R_{Test2}”), as at 422. The A/D converter 308 may then be configured to receive and digitize a third incoming voltage “V2P”, as at 424, at which point the microprocessor 302 may enable the input multiplexer 310 to accept a voltage at the second isolation resistor 138 (“R_{Iso4}”), as at 426.

The A/D converter 308 may then receive and digitize a fourth incoming voltage “V2M”, as at 428, at which point the second measurement of the differential voltage “V2” may be calculated by subtracting V2M from V2P, as at 430. With calculated values of V1 and V2, the total differential voltage swing V_{OUT} may be calculated by taking the difference between V1 and V2, as at 432.

The value of the total differential voltage swing “V_{IN},” however, may depend on the digital I/O voltage supply 314, since the I/O pins 312 are powered from the voltage supply 314, as described above. In an exemplary embodiment, the A/D converter 308 may be used to digitize and then measure the value of the voltage supply 314. To accomplish this, the microprocessor 302 may be configured to enable the input multiplexer 310 to accept the voltage supply 314, as at 434. The A/D converter 308 may then receive and digitize the voltage supply 314, as at 436, at which point V_{IN} may be calculated by multiplying the voltage supply 314 by 2, as at 438.

Since the resistance values of isolation resistors 112, input resistors 114, and test resistors 132 are known, once the total differential voltage swings V_{OUT} and V_{IN} are known, the total skin+electrode impedance R_{Source} may be calculated, as at 440, by employing the following calculations:

R_{Test}=R_{Test1}+R_{Test2}

R_{Input}=R_{In1}+R_{In2}+R_{Iso1}+R_{Iso2}, where R_{In1} and R_{In2} are the known resistances of the input resistors 114, and R_{Iso1} and R_{Iso2} are the known resistances of the isolation resistors 112.

R_{Source}=Z_{Patient1}+Z_{Patient2}+Z_{electrode1}+Z_{electrode2}, where Z_{Patient1} and Z_{Patient2} are the purely resistive impedances of the skin 110, and Z_{electrode1} and Z_{electrode2} are the purely resistive impedances of the electrodes 108. Thus, R_{Source} may be calculated by applying principles of Ohm's law, as follows:

R_{Source}=1/((V_{IN}/V_{OUT}*R_{Test})−1/R_{Test}−1/R_{Input})

The Normal Mode attenuation of the resistive divider A_{Input}, or gain, created by resistances including the skin 110, electrodes 108, isolation resistors 112, and input resistors 114, may be derived from the following equation:

A_{Input}=(R_{In1}+R_{In2})/(R_{Source}+R_{Iso1}+R_{Iso2}+R_{In1}+R_{In2})

In an exemplary embodiment, once the attenuation A_{Input} is determined, the method 400 may then revert back to operation in Normal Mode, where the attenuation A_{Input} may be applied mathematically to compensate for the calculated changes in the impedances of the skin 110 and the electrodes 108.

At this point, a query is once again posed to determine if calibration is needed, as at 404. In the event the newly calibrated value remains valid, the Normal Mode of operation may commence. In an exemplary embodiment, the test signal 130 provided by the tristate I/O pins 312 may be removed by placing the I/O pins 312 into the tristate (i.e., un-driven) mode of operation, as at 442. The input multiplexer 310 may then be enabled to accept output signals from the supplemental filter/gain module 120, as at 444, so that amplified and filtered samples of the biopotential signal 106 may be collected and digitized using the A/D converter 308, as at 446. To compensate for the measured attenuation variations, the incoming biopotential signals 106 may then be divided by the calculated attenuation A_{Input}, as at 448. As can be appreciated, this calculation may be configured to correct errors introduced by a change in the skin/electrode input impedances located at the skin 110 and electrodes 108.

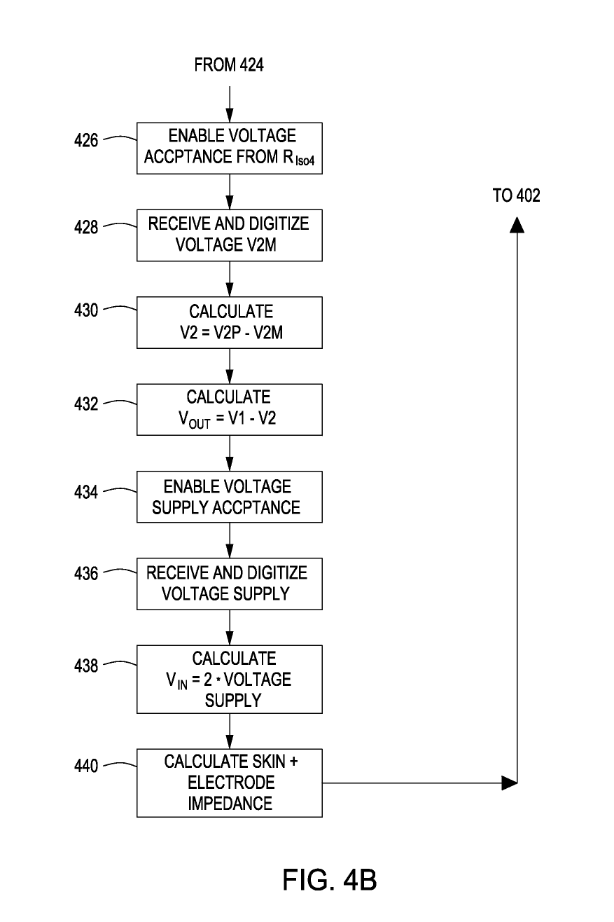

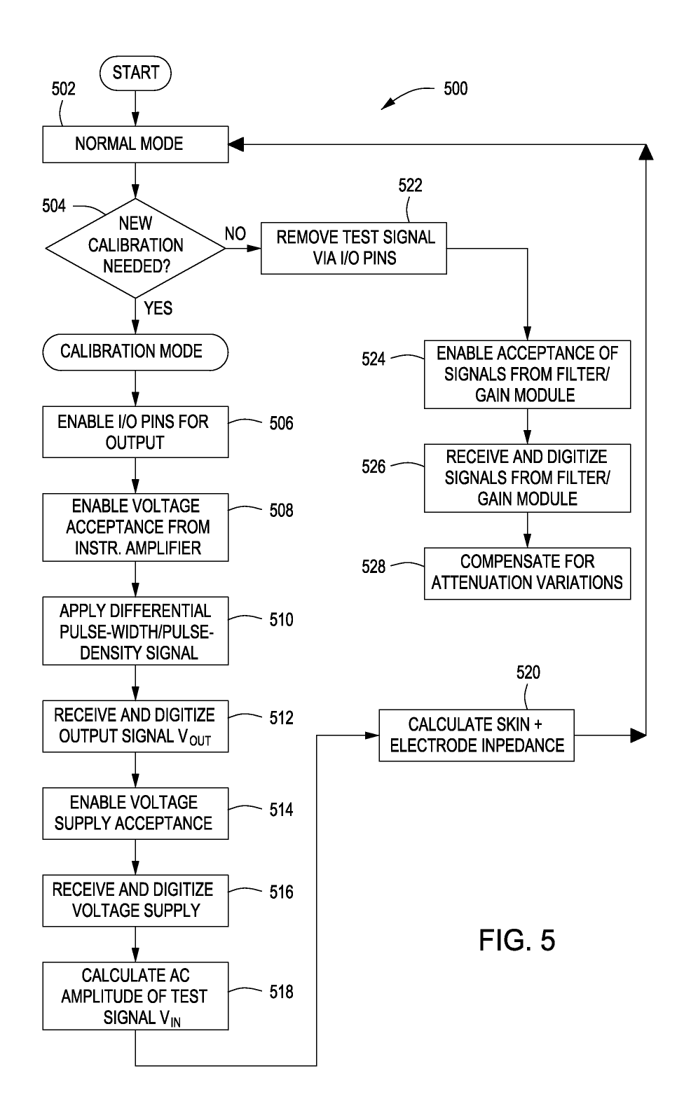

Referring now to FIG. 5, with continued reference to FIG. 3, illustrated is a flowchart describing a method of operation 500 for a Calibration Mode in accordance with the embodiments described above with reference to FIG. 2. As will be shown, the method 500 may be substantially similar to the previous method 400 described with reference to FIG. 4, with at least a few exceptions. For example, instead of measuring the resistances using a differential DC voltage as described in the previous method 400, the method 500 may include I/O pins 312 that are controlled by the software of the microprocessor 302 to produce a pulse-width modulated or pulse-density modulated AC digital signal. Therefore, how the value of the skin/electrode impedance R_{Source} is measured is slightly different.

In an exemplary embodiment, the system 300 (FIG. 3) may initiate operation of the method 500 in the Normal Mode, as at 502. In Normal Mode, a query is posed to determine whether the system 300 should continue in Normal Mode or whether the program flow requires a switch to a Calibration Mode, as at 504. A switch to Calibration Mode may be prompted by, for example, a lapse in time. In at least one embodiment, the system 300 may be configured to calibrate at a predetermined time interval. For example, the system may be configured to calibrate once every 5 minutes, or once every 1 minute.

Upon entering Calibration Mode, the I/O pins 312 may first be enabled for output, as at 506. To acquire a first measurement of the differential voltage between the two electrodes 108, the microprocessor 302 may first be configured to enable the multiplexer 310 to accept a voltage, output signal V_{OUT}, from the output of the instrumentation amplifier 118, as at 508. In an exemplary embodiment, the microprocessor 130 may be configured to calculate the RMS voltage of the output signal V_{OUT}, thereby resulting in a sinusoidal waveform, as explained below.

In at least one embodiment, a differential pulse-width or pulse-density modulated AC digital signal may be applied at the I/O pins 312 through the test resistors 132 (R_{Test1} and R_{Test2}), as at 510. The differential pulse-width/pulse-density modulated digital signal, when channeled through the low-pass filter created by the combination of the isolation resistors 112, input resistors 114, and input capacitors 116, may result in an analog signal, such as a sine wave. In an exemplary embodiment, the frequency of the sine wave may be above the cutoff frequency of the high-pass filter created by the combination of the instrumentation amplifier 118 and servo integrator 124 (FIG. 2), but may also be below the cutoff frequency of the low-pass filter created by the combination of the isolation resistors 112, input resistors 114, and input capacitors 116. The A/D converter 308 may then be configured to receive the output signal V_{OUT} through the multiplexer 310, and digitize the output signal V_{OUT}, as at 512.

Similar to the method 400 described above, the value of the total differential voltage swing V_{IN}, however, may depend on the digital I/O voltage supply 314, since the I/O pins 312 are powered by the voltage supply 314. In an exemplary embodiment, the A/D converter 308 may be used to digitize and then measure the value of the voltage supply 314. To accomplish this, the microprocessor 302 may be configured to enable the input multiplexer 310 to accept the voltage supply 314, as at 514. The A/D converter 308 may then be configured to receive and digitize the voltage supply 314, as at 516.

As those skilled in the art will readily recognize, the amplitude of a pulse-width/pulse-density modulated signal is directly proportional to the amplitude of the digital signal(s) that drive the high and low voltage levels. Therefore, the voltage input 314 should be measured to calculate the AC amplitude of the sinusoidal portion of the test signal V_{IN} supplied by the I/O pins 312, as at 518. In at least one embodiment, the amplitude calculation may be based on the modulation scheme chosen and the value of the voltage input 314. Once the signal amplitude of the input sinusoidal signal V_{IN} produced by the I/O pins 312 is calculated, the value of the skin/electrode resistance R_{Source} can be calculated, as at 520, using substantially similar equations as the previous method 400, and further described below.

In particular, the following equations may again be implemented:

R_{Test}=R_{Test1}+R_{Test2}

R_{Input}=R_{In1}+R_{In2}+R_{Iso1}+R_{Iso2}

R_{Source}=Z_{Patient1}+Z_{Patient2}+Z_{electrode1}+Z_{electrode2}, where Z_{Patient1} and Z_{Patient2} are the purely resistive impedances of the skin 110, and Z_{electrode1} and Z_{electrode2} are the purely resistive impedances of the electrodes 108.

To further utilize the equations of the previous method 400, the AC voltage V_{OUT} at the electrodes 108 may be calculated from the voltage V_{OUT} measured at the output of the instrumentation amplifier 118. This calculation may be performed by dividing by the known gain of the instrumentation amplifier 118 by the known resistive divider gain of the isolation resistors 112 (R_{Iso1} and R_{Iso2}) and input resistors 114 (R_{In1} and R_{In2}) as follows:

V_{OUT}=(V_{OUT}/G_{InstAmp})*((R_{In1}+R_{In2}+R_{Iso1}+R_{Iso2})/(R_{In1}+R_{In2})), where G_{InstAmp} is the known gain of the instrumentation amplifier 118.

R_{Source} may then be calculated through the application of Ohm's law as follows:

R_{Source}=1/((V_{IN}/V_{OUTE}*R_{Test})−1/R_{Test}−1/R_{Input})

The attenuation of the resistive divider Aᵢₙₚᵤₜ formed by resistances from the skin 110, the electrodes 108, the isolation resistors 112, and the input resistors 114 in Normal Mode may be acquired through the following equation:

A_{Input}=(R_{In1}+R_{In2})/(R_{Source}+R_{Iso1}+R_{Iso2}+R_{In1}+R_{In2}).

The attenuation of the resistive divider A_{Input} may then be applied mathematically during Normal Mode in order to compensate for the changes in the impedances of the skin 110 and the electrodes 108.

In an exemplary embodiment, the method 500 may then revert back to operation in Normal Mode 502, where the attenuation A_{Input} may be applied mathematically to compensate for the calculated changes in the impedances of the skin 110 and the electrodes 108. At this point, the need for calibration may once again be determined as previously outlined, as at 504.

In the event the newly calibrated value remains valid, the Normal Mode of operation may commence, as at 522, wherein the test signal 130 provided by the tristate I/O pins 312 is removed by placing the I/O pins 312 into the tristate (i.e., un-driven) mode of operation. The input multiplexer 310 may then be enabled to accept output signals from the supplemental filter/gain module 120, as at 524, so that amplified and filtered samples of the biopotential signal 106 may be collected and digitized using the A/D converter 308, as at 526. To compensate for the measured attenuation variations, the incoming signals may then be divided by the calculated attenuation A_{Input}, as at 528. As can be appreciated, this calculation may be configured to correct errors introduced by a change in the skin/electrode input impedances located at the skin 110 and electrodes 108.

It should be clear to one skilled in the art that the computations outlined in the paragraphs above can be rearranged into many equivalent forms. For example, the gain correction factor applied in the Normal Mode of operation may be applied at any stage of the processing before the signal is displayed. Furthermore, the signal can be corrected before it is processed with digital filters, running average RMS calculations, etc. In other exemplary embodiments, the calibration correction factor may be applied with equivalent results after the signal processing stages disclosed above. Also, it should be evident that the differential measurement techniques presented have equivalent single-ended methods that are more susceptible to noise due to the halving of signal amplitudes of applied input signals and measured output signals.

Very little additional circuitry may be required by the disclosed embodiments to perform the impedance measurement. Thus, additional costs of the present disclosure can be extremely low. In fact, embodiments disclosed herein may provide a less expensive method to correct for skin/electrode impedance variations than is heretofore believed to have been available.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A method for compensating for an impedance variation of a biopotential signal of a patient, comprising:
applying a pair of electrodes to a skin of the patient;
applying a test signal to the skin of the patient via the pair of electrodes;
measuring a combined response to the test signal by the skin and the pair of electrodes; and
calculating an output impedance of the skin and the pair of electrodes using the combined response to obtain a mathematical correction of the biopotential signal of the patient that is used to compensate for the impedance variation caused by the skin and the pair of electrodes.

2. The method of claim 1, wherein the biopotential signal includes one of an ECG, EMG, or EEG electrical signal.

3. The method of claim 1, wherein the test signal is a differential DC signal or a differential AC signal.

4. The method of claim 3, wherein the test signal is a pulse-width modulated AC waveform or a pulse-density modulated AC waveform.

5. The method of claim 1, wherein the mathematical correction is based on Ohm's law.

6. The method of claim 1, wherein the combined response includes a calibration factor which may be applied to a monitoring module using a software algorithm.

7. A system for compensating for an impedance variation of a biopotential signal of a patient, comprising:
electrodes applied to a skin of the patient, wherein the electrodes have selectively variable impedances;
a monitoring module communicably coupled to the electrodes and comprising an amplifier and a supplemental filter/gain module;
a test generating module communicably coupled to the monitoring module and the electrodes and configured to apply a test signal to the electrodes; and
a measurement module having a voltage calibration meter configured to measure a DC level between the electrodes while the test signal is applied to the electrodes, whereby a total impedance of the electrodes and skin is measured and a gain of the monitoring module is adjusted proportionally to account for the impedance variation.

8. The system of claim 7, further comprising a wireless or optical link to a nearby display unit.

9. The system of claim 7, wherein the supplemental filter/gain module comprises a low-pass filter network formed by isolation resistors, input resistors, and input capacitors.

10. The system of claim 9, wherein the supplemental filter/gain module is configured to filter incoming frequencies for electrocardiographic, electromyographic, or electroencephalographic signals.

11. The system of claim 7, wherein the test signal is a differential DC signal.

12. The system of claim 7, wherein the test signal originates with a battery.

13. The system of claim 7, wherein the test generating module comprises switches configured to selectively apply the test signal.

14. The system of claim 7, wherein the measurement module comprises switches configured to communicably couple the voltage calibration module to the electrodes to measure the DC level.

15. A system for compensating for an impedance variation of a biopotential signal of a patient, comprising:
electrodes applied to a skin of the patient, wherein the electrodes have selectively variable impedances;
a monitoring module communicably coupled to the electrodes and comprising an instrumentation amplifier, a supplemental filter/gain module, and a servo integrator;
a test generating module communicably coupled to the monitoring module and the electrodes and configured to apply a test signal to the electrodes; and
a measurement module having a voltage calibration meter configured to measure an AC level between the electrodes while the test signal is applied to the electrodes, whereby a total impedance of the electrodes and skin is measured and a gain of the monitoring module is adjusted proportionally.

16. The system of claim 15, wherein the test signal is a time-varying signal.

17. The system of claim 15, wherein the test signal is a differential AC signal generated using pulse density modulation or pulse width modulation.

18. The system of claim 15, wherein the test generating module comprises switches configured to selectively apply the test signal.

19. The system of claim 15, further comprising a wireless or optical link to a nearby display unit.

20. The system of claim 15, wherein the measurement module comprises switches configured to communicably couple the voltage calibration module to the electrodes to measure the AC level.
